(19) United States
(12) Patent Application Publication
(10) Pub. No.: US 2025/0139385 A1
(43) Pub. Date: May 1, 2025

(54) EFFICIENT IMAGE GENERATION USING ARTIFICIAL INTELLIGENCE

(71) Applicant: Google LLC, Mountain View, CA (US)

(72) Inventors: Krista Lynn Holden, Santa Clara, CA (US); Garima Pruthi, San Jose, CA (US)

(21) Appl. No.: 18/905,007

(22) Filed: Oct. 2, 2024

Related U.S. Application Data
(60) Provisional application No. 63/594,230, filed on Oct. 30, 2023.

(51) Int. Cl. G06F 40/40; G06F 40/186; G06F 40/284; G06T 11/00

(52) U.S. Cl. CPC G06F 40/40; G06F 40/186; G06F 40/284; G06T 11/00

(57) ABSTRACT

Methods, systems, and apparatus, including computer programs encoded on a computer storage medium for using artificial intelligence to generate images are described. In one aspect, a method includes obtaining, by an artificial intelligence system and from one or more data sources, information related to one or more digital components for an item. The obtained information can include an identifier for the item and text presented by at least one of the one or more digital components. The artificial intelligence system generates an image generation prompt based on the obtained information. The image generation prompt includes image generation instructions for generating an image based on the extracted information. The artificial intelligence system provides the image generation prompt to an image generation model trained to generate images based on input image generation prompts. The artificial intelligence system generates an updated digital component using an output image output by the image generation model.

### CROSS-REFERENCE TO RELATED APPLICATION

This application claims priority to U.S. Provisional Patent Application No. 63/594,230, filed on Oct. 30, 2023, the disclosure of which is hereby incorporated by reference in its entirety and for all purposes.

### BACKGROUND

This specification relates to data processing, artificial intelligence, and generating images using artificial intelligence.

Advances in machine learning are enabling artificial intelligence to be implemented in more applications. For example, large language models have been implemented to allow for generating multiple text prompts based on textual features. This allows for more accurate image generation using the generated text prompts.

### SUMMARY

In general, one innovative aspect of the subject matter described in this specification can be embodied in methods that include the actions of obtaining, by an artificial intelligence system and from one or more data sources, information related to one or more digital components for an item including text presented by at least one of the one or more digital components; generating, by the artificial intelligence system, an image generation prompt based on the obtained information, the image generation prompt including image generation instructions for generating an image based on the extracted information; providing, by the artificial intelligence system, the image generation prompt to an image generation model trained to generate images based on input image generation prompts; receiving, as an output of the image generation machine learning model, an output image for the item; and generating, by the artificial intelligence system, an updated digital component using the output image. Other implementations of this aspect include corresponding apparatus, systems, and computer programs, configured to perform the aspects of the methods, encoded on computer storage devices.

These and other embodiments can each optionally include one or more of the following features. In some implementations, generating the image generation prompt includes populating an image generation prompt template based on the extracted information. The image generation prompt template can include at least a portion of the image generation instructions.

In some implementations, generating the image generation prompt includes generating a data extraction prompt for extracting a set of data from the obtained information, providing the data extraction prompt to at least one first language model of a set of one or more language models, receiving, as an output of the at least one first language model, the set of data, generating a prompt generation prompt using the set of data, providing the prompt generation prompt to at least one second language model of the set of one or more language models, and receiving, as an output of the at least one second language model, the image generation prompt.

In some implementations, the at least one first language model is the same as the at least one second language model.

In some implementations, generating the data extraction prompt includes populating a data extraction prompt template with at least a portion of the obtained information, and populating a prompt generation prompt with at least a portion of the set of data.

In some implementations, generating the data extraction prompt for extracting the set of data from the obtained information includes generating, as the data extraction prompt, a prompt that includes instructions for identifying a set of values related to at least a portion of the obtained information, and the prompt generation prompt comprises the set of values.

In some implementations, generating the data extraction prompt for extracting the set of data from the obtained information includes generating, as the data extraction prompt, a prompt that includes instructions for identifying a set of concepts related to at least a portion of the obtained information, and the prompt generation prompt comprises the set of concepts.

In some implementations, the image generation prompt includes the identifier for the item and the text presented by the one or more digital components.

Particular embodiments of the subject matter described in this specification can be implemented so as to realize one or more of the following advantages. The techniques described in this document enable artificial intelligence (AI) to be used to generate new high quality image-based digital components based on large sets of collected information related to existing digital components, a provider of the existing digital components, and/or distribution plans for the existing digital components. Machine learning models, e.g., large language models (LLMs), can be trained to extract salient information from the collected information and/or to generate image generation prompts that instruct image generation models, e.g., text-to-image machine learning models, to generate images based on the instructions and information included in the instructions. This enables the creation of new high quality image-based digital components that effectively convey concepts related to an item that is the subject of the existing digital components, the digital component provider, users to which the digital components are provided, and/or other entities.

The collected data can include structured data collected from specific data sources to enable the machine learning models to accurately identify the salient information that is used to generate the image generation prompt, which results in accurate information being included in the image generation prompt and therefore accurate images output by the image generation model.

Using a chain of prompts that are provided to machine learning models allows each model and/or each stage of the image generation process to focus on a particular task, resulting in more accurate outputs at each stage. For example, using a prompt to a language model to extract salient information from a set of input data enables this prompt and/or language model to focus on this one task, rather than attempting to also generate an image generation prompt or image based on the set of input data. This can also reduce hallucinations and/or other errors in outputs caused by providing too much information to current generative AI models. For example, separating the image generation into multiple stages (and multiple prompts, e.g., one per stage) reduces the amount of information provided to the model at each stage, resulting in more accurate outputs that are used to generate the images.

Using a chain of prompts also enables the use of smaller, less complex, and faster machine learning models to generate accurate output data at each stage, which allows for the images to be generated in response to a query or request for a digital component. Using a more complex model to generate an image based on a large set of input data would take too long to provide the digital component within the milliseconds typically required to provide a digital component in response to a query or request. This also enables some of the stages to be performed offline, e.g., before receipt of a query or request, while enabling some of the stages to be performed after receiving the query or request. In this way, the latency in generating and providing a new image-based digital component is further reduced, while not requiring the storage of large numbers of pre-generated image-based digital components. Thus, using a chain of prompts to generate image-based digital component as described in this document enables the digital components to be generated quickly and efficiently (e.g., using fewer processing cycles and other computing resources) without sacrificing quality or consuming data storage resources that can be used for other data.

The system can generate the prompts using structured prompt templates. The use of structured templates reduces errors that may be introduced in the prompt generation process, ensures high quality outputs of the models, and focuses the models on defined features and/or qualities of the images, while allowing for the creativity of the models to create new images that humans may not have the capability to create. In particular, the use of structured templates ensures high quality outputs because a user can refine the generated prompts from the models and future structured templates based on the refinements. In addition, the system can perform few-shot learning or can fine-tune the models to increase the accuracy of the prompt generation.

For example, absent the described techniques, a user would have to either create the images manually or attempt to generate prompts for machine learning models that result in images that do not accurately convey attributes of an item. Using inaccurate prompts results in multiple requests to the machine learning models to arrive at a suitable image, which wastes the resources used to execute the machine learning models, which can preclude the models from being used for other tasks. This makes debugging or fixing the models difficult, and this also consumes memory resources required to store images that are not of suitable quality and to send multiple images over a network for a user to view the images at a client device before arriving at a suitable image. This wastes network bandwidth and can introduce latency in the network. In contrast, by using a chain of prompts, the system can determine how the outputs of the models deviate from an acceptable range of outputs. Additionally, by using user input at each or at least at some prompts of the chain of prompts, or some other type of input (e.g., a static output check or a model-based check), the system can increase overall efficiency by reducing compute power consumption by outputting more accurate prompts, instead of correcting inadequate prompts.

Using chains of prompts and structured prompt templates as described in this document provides a specific application of AI models to the field of image and digital component generation. For example, the chain of prompts generated using prompt templates guide one or more AI models to generate high quality images and image digital components by extracting particular types of information and then using that information to generate an image generation prompt that is focused on just the most relevant information for generating an image. This solves the many problems with current generative AI models that output hallucinations and other errors due to inputs having exorbitant amounts of information that may not be related to each other.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which images and digital components are generated using artificial intelligence and distributed to client devices.

FIG. 2 is a block diagram illustrating interactions between an artificial intelligence system, a language model, an image generation model, and a client device.

FIG. 3 is a flow chart of an example process for generating digital components based on images created using artificial intelligence.

FIG. 4 a block diagram of an example computer.

Like reference numbers and designations in the various drawings indicate like elements.

### DETAILED DESCRIPTION

This specification describes techniques for enabling artificial intelligence (AI) to generate new image digital components based on existing digital components (and/or data related thereto), information related to a provider of the digital components, information about users to which the digital components are provided, and/or other information as described in detail below. This enables the AI to generate new images that accurately convey the intent of the digital components and/or providers in creative ways of which humans may not be capable.

AI is a segment of computer science that focuses on the creation of models that can perform tasks act autonomously, e.g., with little to no human intervention. AI systems can utilize, for example, one or more of machine learning, natural language processing, or computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

To generate a digital component, an AI system can collect information from one or more data sources, e.g., existing digital components, information provided by a provider of the existing digital components, and/or web pages or other online resources associated with an item (e.g., a product or service) that is the subject of the digital component, and process the information to generate an updated or new digital component. Generally speaking, the system utilizes a chain of prompts to machine learning models to generate an image, which can be used to create a new digital component or serve as the digital component.

The chain of prompts can include one or more data extraction prompts for extracting data, e.g., concepts and/or values, from the collected information, a prompt generation prompt for generating an image generation prompt based on the extracted data, and/or the image generation prompt for generating the image. The system can utilize one or more language models, e.g., large language models (LLMs), to extract the data from the collected information and/or to generate the image generation prompt. The system can provide the image generation prompt as an input to an image generation model, e.g., a text-to-image neural network or diffusion model, that is trained to generate images based on the image generation prompts. The system can receive an output image from the image generation model and generate an updated or new digital component using the output image. Generating digital components in this way enables AI to create new images that accurately convey a set of concepts and/or values of an item and/or of a digital component provider that provides digital components for the item and/or provides the item itself.

As discussed in more detail below, the image generation prompt is specialized (e.g., created or augmented) to improve the overall quality of the generated output image (e.g., the image ad) by performing chain-of-thought prompting. Chain-of-thought prompting includes efficiently extracting information associated with an item using one or more language models in order to generate an accurate output image. Post-processing operations are then used to detect errors associated with generating the updated digital component and can also be used to correct the errors and/or prevent errors in the creation of future images.

Using prompt chains as described herein reduces wasted computing resources that would otherwise generate more low quality image digital components if a more general image generation prompt were used. Similarly, as discussed in more detail below, using the image generation prompt based on prompt chains can save computing resources and generates images faster. For example, by constructing the prompt to determine the type of content for inclusion in the image generation prompt, the image generation model can generate the output image more efficiently, thereby avoiding the creation of low quality or inaccurate output images, which reduces the time required to generate the output image, the memory required to store the data associated with the output image, and the computing resources required to generate and evaluate the output image. This all contributes to a system capable of creating new images faster, such that they can be created and served in a real time interactive environment—e.g., in response to a user search query or digital component request received from a client device of a user. In some examples, the techniques include performing post processing procedures of the output image in order to increase the accuracy of the output image.

In some implementations, the system can use multiple smaller and less complex models in the prompt chain to extract the data, generate the image generation prompt, and to generate the image using the image generation prompt. In such examples, each model can be trained to accurately perform a particular task such that each model is more accurate and faster, which enables the system to generate new images in the milliseconds at which digital components are provided in response to queries and/or requests.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

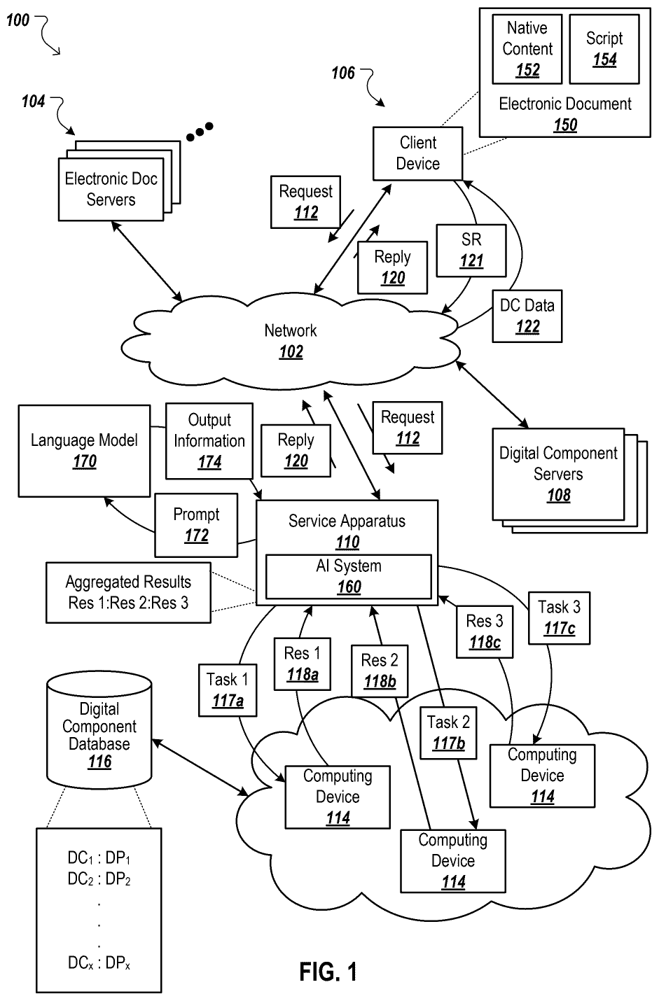

FIG. 1 is a block diagram of an example environment in which generating images using textual features can be performed. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, user devices 106, and digital component servers 108.

The service apparatus 110 is configured to provide various services to client devices 106 and/or publishers of electronic documents 150. In some implementations, the service apparatus 110 can provide search services by providing responses to search queries received from client devices 106. For example, the service apparatus 110 can include a search engine and/or an AI agent or other chat agent that enables users to interact with the agent over the course of multiple conversational queries and responses. The service apparatus 110 can also distribute digital components to client devices 106 for presentation with the responses and/or with electronic documents 150. For example, another search service computer system can send component requests 112 to the service apparatus 110 and these component requests 112 can include one or more queries. The service apparatus 110 and component requests 112 are described in further detail below.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112. In some implementations, choosing a digital component includes choosing a digital component based on textual features, as described in more detail below.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106. The described techniques are adapted to generate a digital component in a short amount of time such that these errors and user experience impact are reduced or eliminated.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device 106 will render the digital component (e.g., third-party content), and present the digital component at a location specified by, or assigned to, the script 154. For example, the script 154 can create a walled garden environment, such as a frame, that is presented within, e.g., beside the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an AI system 160 configured to generate, e.g., autonomously, digital components, either prior to a request 112 (e.g., offline) and/or in response to a request 112 (e.g., online or real-time). As described in more detail throughout this specification, the AI system 160 can collect information about a specific entity and extract data, e.g., summary data, concepts, values, etc., from the collected information using one or more language models 170, which can include large language models (“LLMs”). The entity can be an existing digital component, an item that is the subject of a digital component, a group of existing digital components (e.g., of a common distribution plan or common provider), and/or a digital component provider that provides digital components for distribution to client devices 106 of users.

As described in more detail below, the AI system 160 can also use language models 170 to generate prompts, e.g., image generation prompts, based on input data. For example, the AI system 160 can use language models 160 to generate image generation prompts based on the extracted data. The AI system 160 can provide the image generation prompt to an image generation model that is trained to generate images based on prompts.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Texas?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to the pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

As described in more detail below, the AI system 160 can train and use multiple language models 170 to perform various tasks. For example, different language models can be specially trained to process different prompts at different stages of the processing pipeline. The AI system 160 can train one or more language models 170 to extract particular types of data from collected information and/or one or more language models to generate image generation prompts based on the extracted data. In a particular example, the AI system 160 can train a language model 170 for each type of data to extract and a language model 170 to generate image generation prompts. In another example, the AI system 160 can train, for each type of data to extract, a language model 170 that generates image generation prompts for that type of data.

To generate output information 174 using a language model 170, the AI system 160 can generate a prompt 172 that is submitted to the language model 170, and that causes the language model 170 to generate the output information 174, also referred to simply as “output.” The AI system 160 can generate a prompt 172 in a manner (e.g., having a structure) that includes information for sue by the language model 170 to generate the output information 174. In some implementations, the prompt 172 can include instructions that instruct the language model 170 on the output to generate and data for use in generating the output information 174.

As described in more detail below, the AI system 160 can generate a prompt using a prompt template. A prompt template can include instructions and fields that can be populated with data for use in generating the output information 174. For example, a prompt 172 to generate an image generation prompt can include fields that the AI system 160 populates with concepts or values extracted from collected information. The instructions can be static and/or dynamic. For example, the instructions can be the same for each prompt generated using the prompt template or variable based on the extracted data.

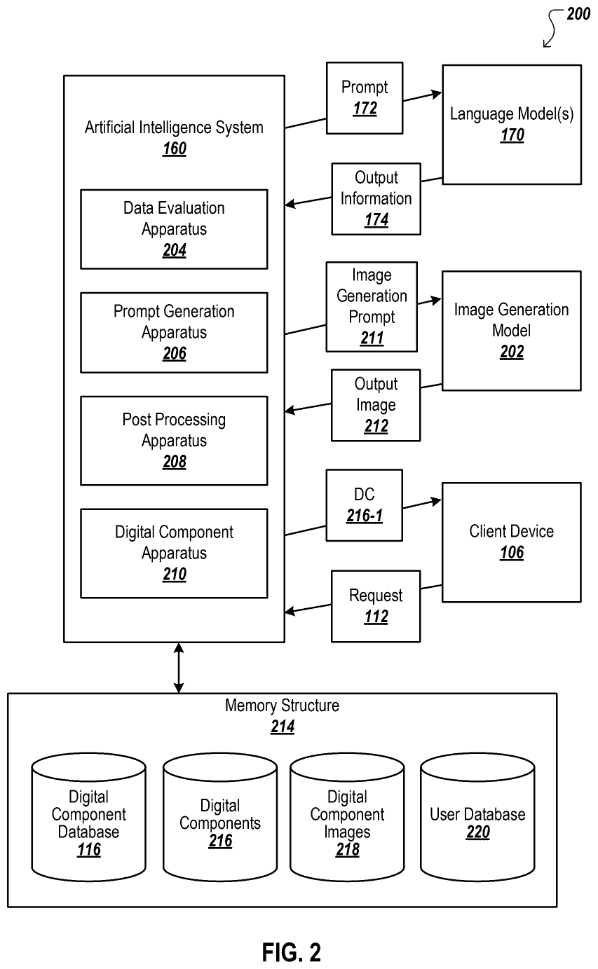

To initiate creation of the output information 174, the AI system 160 submits the prompt 172 to the one or more language models 170, which use the prompt 172 to generate the output information 174. For example, if the prompt is a data extraction prompt, the output information 174 can include a set of values related to the extracted data (e.g., text extracted from the collected data), a set of concepts related to the extracted data (e.g., keywords extracted from the collected information), and/or other types of data as described in further detail below with reference to FIG. 2.

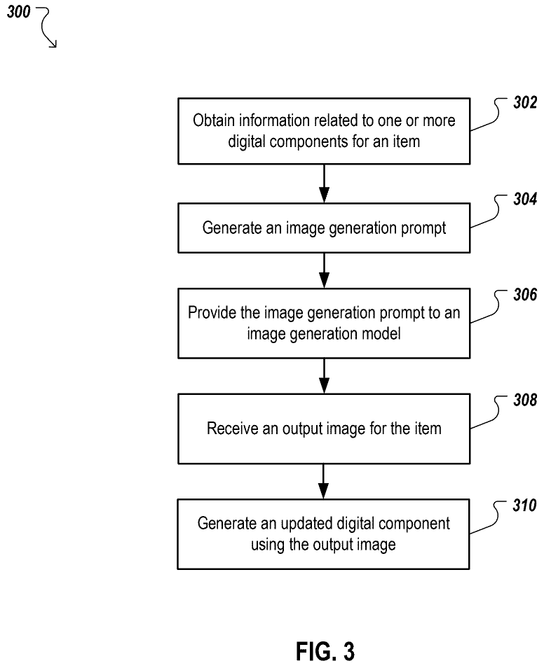

In some implementations, a more general (e.g., larger) language model can be used as part of the process for generating new digital components. For example, a larger language model can be used to extract data from collected information in an offline process, e.g., independent of and/or prior to receipt of a request for a digital component. In this example, the extracted data can be used to generate an image generation prompt and/or to generate an image for a new digital component in real time, e.g., in response to receiving a request 112. In another example, the AI system 160 can generate a digital component as an offline process (e.g., prior to receiving a request 112, and store the digital component for distribution to client devices 106 in response to requests 112. Example processes performed by the AI system 160 to generate digital components is described in detail with reference to FIGS. 2 and 3.

FIG. 2 is a block diagram illustrating interactions between an AI system 160, a language model 170, an image generation model 260, and a client device 106. The AI system 160 can include a data evaluation apparatus 204, a prompt generation apparatus 206, a post processing apparatus 208, and a digital component apparatus 210.

The AI system 160 can also include or be configured to interact with a memory structure 214 to extract and/or store information and content. In particular, the memory structure 224 can store the digital component database 116, digital components 216, images corresponding to the digital components 218, and a user database 220. The memory structure 224 can include one or more databases or other data structures stored on one or more memories and/or data storage devices.

As described above, the digital component database 116 can include distribution parameters for digital components 216. The distribution parameters for a digital component 216 can include, for example, keywords and/or geographic locations for which the digital component 216 is eligible to be distributed to client devices 106. The digital component database 116 can also include, for each digital component 216, an identifier of an item (e.g., product or service) that is the subject of the digital component, metadata of the digital component, a caption for each image 218 corresponding to the digital component, data related to the digital component provider that provides the digital component, text of the digital component (e.g., text depicted by the digital component), and/or other data related to the digital component. The data related to the digital component provider can include an identifier (e.g., name) of the provider, a distribution plan for digital components of the provider (e.g., a maximum amount to be provided over a given time period in response to the provider's digital components being sent to client devices 106), and/or other appropriate digital component provider information.

The digital component database 116 can also include data related to groups of digital components, e.g., for a group of digital components that are distributed according to a common distribution plan. The data for a group of digital components can include aggregated data for the digital components in the group, distribution parameters (e.g., keywords and/or location) for the group, an identifier (e.g., name) for the group, and/or a maximum amount to be provided over a given time period for the group. The data stored in the digital component database 116 can be referred to collectively as collected information or digital component information.

The digital components 216 can include candidate digital components that can be provided in response to component requests 112 and/or queries received by the service apparatus 110. Digital component providers can provide, to the service apparatus 110, candidate digital components to be distributed to client devices 106 of users. Such candidate digital components can be stored by the AI system 160 in the memory structure 214. The AI system 160 can also store digital components generated by the AI system 160 in the memory structure 214.

The images 218 can include one or more images for each digital component 216. As described above, the AI system 160 can obtain images for digital component 216 from the digital component providers or from other sources, e.g., by crawling web pages and/or other resources related to or linked to by the digital component and/or resource of the digital component provider that provides the digital component. The AI system 160 can use the images 218 to generate customized digital components, as described herein.

The data evaluation apparatus 204 can be configured to obtain the images 218 and/or at least some of the data stored in the digital component database 116. For example, the data evaluation apparatus 204 can be configured to extract text and/or keywords for a digital component from the digital component itself, from metadata for the digital component, from the distribution parameters for the digital component, and/or from web pages and/or other resources related to (e.g., linked to by) the digital component.

The user database 220 can store information related to users. The information can include, for example, queries received from the user, e.g., in component requests 112 and/or queries sent to the service apparatus 110 for an AI agent provided by the service apparatus 110. The AI system 160 can indicate, in the user database 220, which queries are from past user sessions and which queries are from a current user session. The user session can be a user session with a search system (e.g., a search engine of the service apparatus 110 or an external search engine that submits component requests) or an AI agent.

A user session can be defined by a start event and an end event. The start event can be the opening or launching of the search interface at the client device 106 or receipt of a first query from the client device 106. For example, the start event can be when the user navigates to a search interface provided in a web page or the opening of a native application that includes the search interface. The end event can be the closing of the search interface or a navigation from the web page that includes the search interface. The end event can also be based on a duration of time since a last query has been received. For example, the AI system 160 can determine that a user session has ended if no queries are received from the client device 106 for at least a threshold period of time, e.g., five minutes, ten minutes, one hour, or another time period.

The data evaluation apparatus 204 can also be configured to evaluate the collected information stored in the digital component database 116 for use in generating new digital components. For example, the data evaluation apparatus 204 can be configured to extract, from the collected data, a name of an item that is the subject of one or more digital components, a media location from which the item can be obtained (e.g., application store for an application or from web page), a physical location conveyed by the digital component(s), a text description of the item, link text of link(s) of the digital component(s), calls to action of digital component(s) having calls to action, text that a digital component provider of the digital component(s) has designated as important, one or more color(s) that are specific to the digital component(s) (e.g., background and/or text color), and/or an occasion or event corresponding to the digital component(s) or item. In some implementations, the data evaluation apparatus 204 can be configured to use specific queries to extract this data from the collected information.

The prompt generation apparatus 206 can be configured to generate prompts for one or more language models 170 and/or the image generation model 202. The prompt generation apparatus 206 can generate data extraction prompts and prompt generation prompts for the language model(s) 170. A data extraction prompt can include instructions for outputting specific types of data based on at least a portion of the collected data for an entity. As described above, the entity can be an existing digital component, an item that is the subject of a digital component, a group of existing digital components (e.g., of a common distribution plan or common provider), and/or a digital component provider that provides digital components for distribution to client devices 106 of users.

The prompt generation apparatus 206 can generate data extraction prompts for instructing the language model(s) 170 to output various types of data for the entity. For example, the prompt generation apparatus 206 can generate respective data extraction prompts for the language model(s) to output concepts related to the entity (e.g., categories for the entity), values of the entity, emotions related to the entity, adjectives related to the entity, a subject of the entity, a set of users that may be interested in the entity (e.g., an audience of the entity), and/or other data related to the entity.

As described above, the prompt generation apparatus 206 can generate the prompts using prompt templates that include instructions and fields that can be populated. An example template for instructing a language model 170 to output concepts can be “List the main concepts associated with the following terms: < >, < >, < >, < >, < >. The list should be comma separated.” The symbols < > represent fields that can be populated with text, e.g., keywords of distribution parameters from the collected information for the entity. The template can include fields for any number of keywords or other data. The template is not restricted on the number of terms that can be set by the prompt generation apparatus 206. In particular, the prompt generation apparatus 206 can generate an example template that includes a list of undetermined size (e.g., an undetermined number of terms), and the prompt generation apparatus 206 can combine (e.g., join) each of the number of terms with commas to generate a string. The generated string includes the comma separated terms, and the prompt generation apparatus 206 can generate a single input field (e.g., input term < >) with the generated string.

A prompt template can specify the type of data for each field that can be populated with data. The data evaluation apparatus 204 can be configured to identify, for the entity, data of each data type for each field and provide the data to the prompt generation apparatus 206. The prompt generation apparatus 206 can populate the prompt template with the data to generate a prompt 172 and provide the prompt to a language model 170.

Continuing the previous example, a populated data extraction prompt for concepts can be “List the main concepts associated with the following terms: Company A washer and dryer, washer and dryer set, washer, dryer, laundry appliance. The list should be comma separated.” The AI system 160 can provide this prompt 172 to a language model 170 trained to output concepts in response to prompts 172 and the language model 172 can return output information 174 that includes concepts based on the prompt 172. In this example, the output information 174 can be “consumer electronics, home appliances, laundry equipment,” which is a list of concepts separated by commas per the prompt 172. This can be used to identify categories of keywords used to distribute the digital components, which can then be used to generate images that convey these categories.

An example prompt template for a data extraction prompt for instructing a language model 170 to output values, e.g., salient values, for an entity can be “List three values conveyed in the following digital components: < >, < >, < >, < >, < >.” In this example the fields < > can be populated with text extracted from digital components in a group of digital components, e.g., a group of digital components having a common distribution plan, having a common item that is the subject of the digital components, or having a common digital component provider. A populated data extraction template for values can be “List three values conveyed in the following digital components: Free delivery on $499+, Price Match Guarantee, We Won't Be Beat on Price, Free Shipping $45+, Applicant Repair 20% Off.” The AI system 160 can provide this prompt 172 to a language model 170 trained to output values in response to prompts 172 and the language model 172 can return output information 174 that includes values based on the prompt 172. In this example, the output information 174 can be “convenience, value, security,” which is a list of values per the prompt 172. This can be used to identify the important values of a digital component provider for an item, which can reflect the intent and/or goals of the digital component provider and can be used to generate images that also reflect these values.

An example prompt template for a data extraction prompt for instructing a language model 170 to output emotions evoked by an entity can be “What is the emotion evoked in the digital component for <item> in a distribution plan from <digital component provider> that uses the slogans: <digital component text>. Give only the answer.” In this example, the field <item> can be populated with an identifier (e.g., name) for an item; the field <digital component provider> can be populated with an identifier (e.g., name) of a digital component provider; and the field <digital component text> can be populated with text extracted from one or more digital components for the item. The AI system 160 can provide this prompt 172 to a language model 170 trained to output emotions in response to prompts 172 and the language model 172 can return output information 174 that includes a list of emotions based on the prompt 172. In this example, the output information 174 can be “convenience, value, security,” which is a list of values per the prompt 172.

An example prompt template for a data extraction prompt for instructing a language model 170 to output adjectives that describe an entity can be “List three adjectives describing <item> in a distribution plan for <digital component provider> that uses the slogans: <digital component text>. Give only the answer.” Similar to the previous example, the field <item> can be populated with an identifier (e.g., name) for an item; the field <digital component provider> can be populated with an identifier (e.g., name) of a digital component provider; and the field <digital component text> can be populated with text extracted from one or more digital components for the item. The AI system 160 can provide this prompt 172 to a language model 170 trained to output adjectives in response to prompts 172 and the language model 172 can return output information 174 that includes a list of adjectives based on the prompt 172.

In the previous example, the AI system 160 can extract adjectives based on features of entities related to an item that is the subject of one or more digital components using a data extraction prompt. The AI system 160 can also be configured to extract the adjectives by identifying the subject of a digital component description and generating adjectives specific to that subject. The AI system 160 can use a first prompt to identify the subject of the digital component based on the features and use a second prompt that is based on the subject to identify the adjectives. For example, the prompt generation apparatus 210 can generate the first prompt using the prompt template “A digital component description by <digital component provider> for a <distribution plan>: <image description>” and instructions “Your task is to determine the subject of the digital component description.” In this example, the <digital component provider> and the <distribution plan> include digital component information, and the <image description> can be an input to the image generation model 202 that includes a visual description of the output image 212. The system can use the first prompt to generate determine a particular feature that is the subject of the digital component, which can later be used as the focal point of the image. For example, the system can populate the first prompt to generate an output image for a dog accessory item, where a dog can be the focal point.

The prompt generation apparatus 210 can generate the second prompt using the prompt template “<subject>: <digital component text>” with instructions “Your task is to give three visually descriptive attributes of the subject that are related to the digital component.”

An example prompt template for a data extraction prompt for instructing a language model 170 to output features that describe a set of users that may be interested in an entity can be “Who is the intended audience for the following digital component for <item> from <digital component provider>: <digital component text>. Give only the answer.” In this example, the field <item> can be populated with an identifier (e.g., name) for an item; the field <digital component provider> can be populated with an identifier (e.g., name) of a digital component provider; and the field <digital component text> can be populated with text extracted from one or more digital components for the item. The AI system 160 can provide this prompt 172 to a language model 170 trained to output audience features in response to prompts 172 and the language model 172 can return output information 174 that includes a list of adjectives based on the prompt 172. Example outputs of the language model 170 can be “people who own dogs and enjoy hiking” for a dog accessory item or “people who are looking for a way to reduce noise in their environment” for an earplugs item.

The AI system 160 can also use audience features to identify values for an entity, which can be used in place of or in combination of the techniques for identifying features for an entity described above. An example prompt template for identifying values for an entity using audience features can be “What are three descriptors that the following digital component by <digital component provider> is trying to convince <audience features> about <item>: <digital component text>. Give only the answer.” In this example, the field <item> can be populated with an identifier (e.g., name) for an item; the field <digital component provider> can be populated with an identifier (e.g., name) of a digital component provider; the field <digital component text> can be populated with text extracted from one or more digital components for the item; and the field <audience features> can be populated with the audience features, e.g., the output of the language model 170 for the data extraction prompt for outputting the features that describe a set of users that may be interested in an item. The AI system 160 can provide this prompt 172 to a language model 170 trained to output audient features in response to prompts 172 and the language model 172 can return output information 174 that includes a list of adjectives based on the prompt 172. Example outputs of the language model 170 can be “people who own dogs and enjoy hiking” for a dog accessory item or “people who are looking for a way to reduce noise in their environment” for an earplugs item.

The previous example is just one example of how a chain of prompts can be used to extract data for an entity for use in generating an image. The AI system 160 can use the prompt generation apparatus 206 to generate data extraction prompts for any combination of multiple types of data, e.g., concepts and values or concepts and adjectives, described herein. In some cases, one data extraction prompt may include or otherwise use the output of another data extraction prompt. In this example, the prompt generation apparatus 206 can generate and provide the prompts to the language model(s) 170 in a sequence. In other examples, the prompt generation apparatus 206 can generate and provide the prompts to the language model(s) 170 in parallel. This can reduce the latency in extracting the data for use in generating an image generation prompt.

In some implementations, the AI system 160 can train and use the same language model 170 for each type of data extraction prompt, e.g., for each type of data to be extracted from the collected information. This can enable the use of smaller and faster language models than using a single language model that is trained to identify multiple different types of data. This also allows for parallel prompt evaluation by the different language models. This all results in the ability to generate prompts and evaluate prompts in real time in response to a query or request for a digital component.

In some examples, the training process uses few-shot learning to train the one or more language models 170 to convert the set of training prompts and ground truth images into an image generation prompt. In particular, few-shot learning can include training relatively small language models in order to generate prompts for chain-of-thought prompting, where each of the one or more language models is used to generate a respective prompt. In this case, training the relatively small language models 170 can be generally more efficient than training a larger language model, which allows for the system to “chain” each of the trained models together to ultimately generate the image generation prompt 211.

In some implementations, the system can use sample ground truth images (e.g., a sample input and a sample output) generated through few-shot learning to train the language models 170. For example, the prompt generation apparatus 206 can develop a prompt template for an image generation prompt 211. Additionally, the prompt generation apparatus 206 can obtain sample inputs and sample outputs, such as sample images, associated with the desired image generation prompt 211. Here, an input sample can be concepts and/or values and an output sample for the input sample can be an image generated based on the input sample. In another example, the input sample can be an image and the output sample for the input sample can be concepts and/or values corresponding to the image. In some examples, for each of the samples, the prompt generation apparatus 206 can perform zero-shot learning executions in order to generate the samples by providing a respective prompt used for generating the respective sample. The prompt generation apparatus 206 can then manually refine from the zero-shot executions to select from multiple samples in order to generate a final sample set. The final sample set includes the sample inputs and the generated sample outputs. The prompt generation apparatus 206 can then store the selected final sample set.

In some implementations, a language model 170 can be used for multiple types of data. To reduce latency at query or request time, the language model 170 can be used to extract the data prior to receiving the query or request, e.g., as an offline process.

The prompt generation apparatus 206 is configured to generate an image generation prompt 211 based on data extracted from the collected information. The prompt generation apparatus 206 can generate an image generation prompt 211 based on the data output by the language model(s) 170 using one or more of the data extraction prompts described above. For example, the prompt generation apparatus 206 can generate an image generation prompt 211 based on the concepts, values, adjectives, emotions, subject, audience features, and or any combination thereof.

In general, an image generation prompt 211 instructs the image generation model 202 to generate an image based on the image generation prompt 211. The image generation prompt 211 can include instructions that instruct the image general model 202 to generate the image. Thus, using the data extracted for an entity, the image generation prompt 211 can instruct the image generation model 202 to generate an image based on that data. For example, the image generation prompt 211 can instruct the image generation model 202 to generate an image that depicts a background and/or objects based on the extracted concepts and that conveys the extracted values.

In some implementations, the prompt generation apparatus 206 can generate an image generation prompt 211 by populating (e.g., filling in) an image generation prompt template with the extracted data, such that the image generation prompt template includes instructions for generating an image based on the extracted information. For example, the image generation prompt template can include “write an image generation prompt for an image for: <item> by <digital component provider>.” In this example, the field <item> can be populated with an identifier (e.g., name) for an item and the field <digital component provider> can be populated with an identifier (e.g., name) of a digital component provider. In some examples, the image generation prompt 211 can include, as part of the instructions, constraints for the image generation prompt 211, such as refraining from including text or people. Using such constraints can result in higher quality images and reduced processing by the image generation model 202 by constraining the image generation to features that are important for the image and not wasting resources on other aspects.

In some implementations, the image generation prompt template can include fields that can be populated with extracted data, e.g., a set of keywords, concepts, values, adjectives, emotions, subject, audience features, and or any combination thereof. For example, the image generation template can also include “the image should convey the values of <values>. The image should match the categories of <keywords>.” In this example, the field <values> can be populated with the values obtained using a data extraction prompt and the field <keywords> can be populated with the keywords associated with digital components for the item. The prompt generation apparatus 206 can then populate the image generation prompt template with the corresponding extracted data to generate the image generation prompt 211.

In another example, the image generation template can be “The image should look <adjectives> and convey <emotion list>.” In this example, the prompt generation apparatus 206 can populate the field <adjectives> with the adjectives obtained using a data extraction prompt and the field <emotion list> with the emotions obtained using a data extraction prompt.

In some implementations, the AI system 160 can use a language model 170 to generate the image generation prompt based on the extracted data that is obtained using the data extraction prompt(s). For example, rather than directly populating an image generation prompt, the prompt generation apparatus 206 can populate a prompt generation prompt that instructs a language model 170 to generate an image generation prompt based on the extracted data. For example, a prompt generation prompt can be “Write a photo generation prompt for a digital component for <item> by <digital component provider>. The image should convey the values of <values>. The image should match the keywords of <keywords>. There should be not people or text in the photo. Answer with just one single prompt.” In this example, the field <item> can be populated with an identifier (e.g., name) for an item; the field <digital component provider> can be populated with an identifier (e.g., name) of a digital component provider; the field <values> can be populated with the values output by a language model 170 based on a data extraction prompt; and the field <keywords> can be populated with keywords associated with one or more digital components for the item, e.g., keywords of the distribution parameters for the digital component(s). In this example, the image generation prompt 211 would be based on the values and keywords associated with the item and its digital component(s).

In some examples, the AI system 160 can populate the prompt generation prompt using samples from the final sample set selected through few-shot learning. In this example, the AI system 160 can insert the samples into the prompt generation prompt and provide the prompt generation prompt to the language model 170. In some cases, the AI system 160 can populate the prompt generation prompt with a relatively large number of samples, which can increase the accuracy of the prompt.

For example, when populating the prompt with two samples (e.g., sample 1 and sample 2), the resulting image generation prompt can be: “Write a photo generation prompt for a digital component with: <sample 1 input> <sample 1 output> <sample 2 input> <sample 2 output>. Answer with just one single prompt.” The samples can be concepts, values, or other features, as described herein.

As another example, the resulting prompt generation prompt for a washer and dryer set offered by Company A can be “Write a photo generation prompt for a digital component for Washer and Dryer set by Company A. The image should convey the values of Convenience, Value, and Security. The image should match the keywords of washer and dryer, washer and dryer set, washer, dryer, laundry appliance, best buy washer. There should be no people or text in the photo. Answer with just one single prompt.”

Another example prompt generation prompt template can be “Write a photo generation prompt for a digital component for <item> by <digital component provider>. The image should convey the values of <values>. The image should be in the categories of <concepts>. There should be no people or text in the photo. Answer with just one single prompt.” The difference between this example prompt generation prompt and the previous example is that this template is populated with concepts obtained using the data extraction prompt rather than keywords. This enables the AI system 160 to generate images that show objects and/or backgrounds according to those concepts. Although these examples include values and keywords or concepts, other templates can include other types of collected information and/or extracted data, e.g., emotions, adjectives, etc.

The AI system 160 can provide the prompt generation prompts 172 to a language model 170 trained to output image generation prompts in response to prompts 172 and the language model 172 can return output information 174 that includes an image generation prompt 211 based on the prompt 172. An example output image prompt for the first example prompt generation prompt provided above may be “A close-up photo of a clean, white laundry room with a washer and dryer set in the corner. The image should be well-lit and have a modern, minimalist aesthetic. The washer and dryer should be the focal point of the image, and should be shown in a way that conveys their convenience, value, and security.”

Regardless of how the image generation prompt 211 is generated, the AI system 160 can provide the image generation prompt 211 to the image generation model 202 to generate an output image 212 based on the image generation prompt 211. The image generation model 202 can generate the output image 212 based on the image generation prompt 211 and provide the output image to the AI system 160.

The image generation model 202 can be implemented as a machine learning model that is trained to generate output image 212. In some implementations, the image generation model is implemented as a text-to-image neural network. The training process can use a set of training prompts and the selected final sample set corresponding to the training prompts. Based on this set of training prompts, the image generation model 202 can be trained to generate output images based on image generation prompts. By using multiple features of the extracted information associated with the item (e.g., chain-of-thought prompting), the AI system 160 can more efficiently generate an accurate output image 212 based on the provider.

In some examples, the post processing apparatus 208 can perform one or more post-processing operations that evaluate one or more characteristics of the image generation prompt 211. The post processing apparatus 208 can detect whether the image generation prompt 211 includes one or more errors, such as hallucinations. Hallucinations may be caused by ambiguous or undefined terms included in the image generation prompt 211, or errors in visual element processing in the image generation process. In some examples, using few-shot learning, the AI system 150 can adjust the training prompts, the selected final sample set, or both, based on evaluating one or more characteristics of the output image 212, as described below.

The post processing apparatus 208 can evaluate the images based on performance and/or match to the image generation prompts used to generate the images. The performance of images can be measured based on user interaction rates (e.g., click-through rates) of digital components generated based on the images and/or conversion rates for the digital components. For example, after an image is generated, the image can be used to generate digital components for the item, as described below. The performance of these digital components can be measured and used to evaluate the images for future digital component generation processes.

The post processing apparatus 208 can also use the performance of similar images to predict the performance of a generated image. For example, the post processing apparatus 208 can evaluate the similarity of a generated image, e.g., using a trained machine learning model, with other images for which performance measurements are available. The post processing apparatus 208 can identify one or more of the most similar images and predict the performance of the generated image using those performance measurements. In one example, the post processing apparatus 208 can use the performance measurement of the most similar image as the predicted performance measurement for the generated image. In another example, the post processing apparatus 230 can aggregate the performance measurements of the top N most similar images, where N is a specified number or a number of images that have at least a threshold similarity with the generated image. The aggregation can be the average of the performance measurements, a weighted average using weights that are proportional to the similarity between the similar image and the generated image, or other measures of central tendency.

The level of match of images can be determined using a machine learning model. For example, a machine learning model can be trained to evaluate the level of match between the image and the image generation prompt. The level of match can be a percentage match or other score that indicates the level of match.

The post processing apparatus 208 can determine an overall score for each image based on the performance and level of match. As described above, each individual measure for an image can be weighted based on importance or other factors when determining the overall score for the image. The post processing apparatus 208 can select one or more images for use in generating a digital component based on the overall score. For example, the post processing apparatus 208 can select each image having at least a threshold score or a predetermined number of the images having the highest scores, e.g., the images corresponding to the three highest overall scores.

The digital component apparatus 220 is configured to generate digital components for items based on the selected image(s). The digital component apparatus 210 can generate a digital component by adding an image of the item or text related to the item to the output image. In some implementations, the digital component apparatus 210 can generate an image editing prompt based on the image and the item. For example, the image editing prompt can include instructions for placing an image of the item within the output image 212. The digital component apparatus 240 can provide the image 212, an image of the item, and the image editing prompt to the image generation model 202 or a different image editing machine learning model. The model can provide a response that includes an image-based digital component that includes the output image 212 with the item included therein.

In some implementations, the image generation model 202 can generate the digital component using inpainting techniques. For example, the image generation model 202 can be trained using object detectors for generating inpainting masks. Such training allows the image generation model 202 to modify a specific portion of the output image 212 to include the image of the item based on the image editing prompt.

The digital component apparatus 210 can be configured to generate a digital component(s) 216-1 in response to component requests 112 and/or prior to receiving component requests 112. The digital component apparatus 210 can also be configured to provide the generated digital components 216 to the client device 106 that provided the component request 112.

FIG. 3 is a flow chart of an example process 300 for generating digital components based on images created using artificial intelligence. Operations of the process 300 can be performed, for example, by the service apparatus 110 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300.

The system obtains, from one or more data sources, information related to one or more digital components for an item (302). In some implementations, the information is provided by a given content provider that provides the digital components. For example, the information can include an identifier for the item and text presented by the one or more digital components. The identifier can be a name of the item, a type of the item, or a campaign name of the item from a provider.

The identifier and text can be provided by a given content provider (or another entity) that is requesting one or more combinations of the identifier and the text to be combined to one or more digital components. The source of the identifier and the text can be a given second level domain or domain server. The information is associated with data of a product (e.g., the item). In some examples, the information includes digital components associated with the item, keywords associated with the item, or both.

The system generates an image generation prompt based on the information (304). As described above, the system can generate an image generation prompt using a chain of prompts to one or more language models. The chain of prompts can include one or more data extraction prompts to extract particular types of data from the obtained information and/or a prompt generation prompt for generating the image generation prompt. In another example, the system can generate the image generation prompt by populating an image generation prompt template with at least a portion of the obtained information and/or extracted data.

The system can more efficiently generate an image with relevant data, such as particular items, using the image generation prompt.

In some examples, the system generates the image generation prompt by generating a data extraction prompt for extracting a set of data from the obtained information. The data extraction prompt allows for the system to generate the image with the relevant data. For example, for a given item, the data extraction prompt can extract a set of data from obtained information about the item that a user deems particularly relevant for generating an image.

The system can provide the data extraction prompt to at least one first language model of a set of one or more language models and receive the set of data as an output of the at least one first language model. The one or more language models can leverage the context of the data extraction prompt to generate the set of data.

The system can then generate a prompt generation prompt using the set of data and provide the prompt generation prompt to at least one second language model of the set of one or more language models. The system can then receive the image generation prompt as an output of the at least one second language model. In some examples, the at least one first language model is the same as the at least one second language model. The one or more language models can be relatively smaller models that allow for faster text generation.

In some examples, the system can generate the data extraction prompt by populating a data extraction prompt template with at least a portion of the obtained information and populating a prompt generation prompt with at least a portion of the set of data. In some examples, the system can generate the data extraction prompt by generating a prompt that includes instructions for identifying a set of values related to at least a portion of the obtained information, and the prompt generation prompt includes the set of values.

In some examples, the system can generate the data extraction prompt by generating a prompt that includes instructions for identifying a set of concepts related to at least a portion of the obtained information, and the prompt generation prompt includes the set of concepts.

By generating the data extraction prompt and the prompt generation prompt and processing the prompt generation prompt to generate the image generation prompt, the system uses chain-of-thought prompting to leverage the one or more language models to create an image that captures relevant features of what a user has defined without focusing on the obtained information (e.g., existing text assets). In particular, chain-of-thought prompting allows for the system to interpret the obtained information in certain formats to create an image generation prompt with a selected set of extracted features. Additionally, in the case where the one or more language models are relatively smaller models, the system can preserve the speed of the language models in generating text while combining the language models to accomplish a larger text generation task, such as creating an image generation prompt with the selected set of extracted features.

The system provides the image generation prompt to an image generation model (306). As described above, the image generation model is configured to generate images based on input image generation prompts.

The system can receive an output image for the item (308) and generate an updated digital component using the output image (310).

In some implementations, an image of the item can be overlaid on the output image with one set of visual characteristics, and then iteratively changed to iteratively evaluate different sets/combinations of modifications. The image digital component can include a link to a landing page and/or other data that enables a client device to display the image digital component.

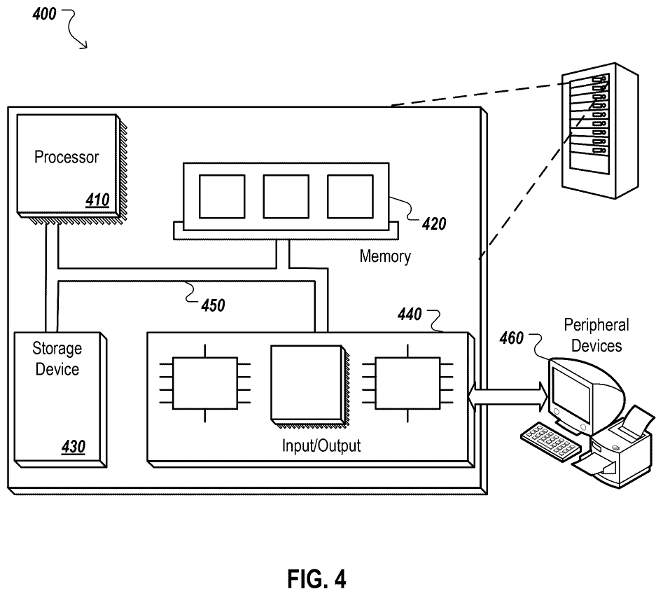

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
obtaining, by an artificial intelligence system and from one or more data sources, information related to one or more digital components for an item comprising text presented by at least one of the one or more digital components;
generating, by the artificial intelligence system, an image generation prompt based on the obtained information, the image generation prompt comprising image generation instructions for generating an image based on the extracted information;
providing, by the artificial intelligence system, the image generation prompt to an image generation model trained to generate images based on input image generation prompts;
receiving, as an output of the image generation machine learning model, an output image for the item; and
generating, by the artificial intelligence system, an updated digital component using the output image.

2. The method of claim 1, wherein generating the image generation prompt comprises populating an image generation prompt template based on the extracted information, wherein the image generation prompt template comprises at least a portion of the image generation instructions.

3. The method of claim 1, wherein generating the image generation prompt comprises:
generating a data extraction prompt for extracting a set of data from the obtained information;
providing the data extraction prompt to at least one first language model of a set of one or more language models;
receiving, as an output of the at least one first language model, the set of data;
generating a prompt generation prompt using the set of data;
providing the prompt generation prompt to at least one second language model of the set of one or more language models; and
receiving, as an output of the at least one second language model, the image generation prompt.

4. The method of claim 3, wherein the at least one first language model is the same as the at least one second language model.

5. The method of claim 3, wherein generating the data extraction prompt comprises:
populating a data extraction prompt template with at least a portion of the obtained information; and
populating a prompt generation prompt with at least a portion of the set of data.

6. The method of claim 3, wherein:
generating the data extraction prompt for extracting the set of data from the obtained information comprises generating, as the data extraction prompt, a prompt that includes instructions for identifying a set of values related to at least a portion of the obtained information; and
the prompt generation prompt comprises the set of values.

7. The method of claim 3, wherein:
generating the data extraction prompt for extracting the set of data from the obtained information comprises generating, as the data extraction prompt, a prompt that includes instructions for identifying a set of concepts related to at least a portion of the obtained information;
the prompt generation prompt comprises the set of concepts.

8. The method of claim 1, wherein the image generation prompt comprises the identifier for the item and the text presented by the one or more digital components.

9. The method of claim 1, wherein the obtained information comprises an identifier for the item.

10. An artificial intelligence system comprising:
one or more processors; and
one or more storage devices storing instructions that, when executed by the one or more processors, cause the one or more processors to perform operations comprising:
obtaining, by the artificial intelligence system and from one or more data sources, information related to one or more digital components for an item comprising text presented by at least one of the one or more digital components;
generating, by the artificial intelligence system, an image generation prompt based on the obtained information, the image generation prompt comprising image generation instructions for generating an image based on the extracted information;
providing, by the artificial intelligence system, the image generation prompt to an image generation model trained to generate images based on input image generation prompts;
receiving, as an output of the image generation machine learning model, an output image for the item; and
generating, by the artificial intelligence system, an updated digital component using the output image.

11. The system of claim 10, wherein generating the image generation prompt comprises populating an image generation prompt template based on the extracted information, wherein the image generation prompt template comprises at least a portion of the image generation instructions.

12. The system of claim 10, wherein generating the image generation prompt comprises:
generating a data extraction prompt for extracting a set of data from the obtained information;
providing the data extraction prompt to at least one first language model of a set of one or more language models;
receiving, as an output of the at least one first language model, the set of data;
generating a prompt generation prompt using the set of data;
providing the prompt generation prompt to at least one second language model of the set of one or more language models; and
receiving, as an output of the at least one second language model, the image generation prompt.

13. The system of claim 12, wherein the at least one first language model is the same as the at least one second language model.

14. The system of claim 12, wherein generating the data extraction prompt comprises:
populating a data extraction prompt template with at least a portion of the obtained information; and
populating a prompt generation prompt with at least a portion of the set of data.

15. The system of claim 12, wherein:
generating the data extraction prompt for extracting the set of data from the obtained information comprises generating, as the data extraction prompt, a prompt that includes instructions for identifying a set of values related to at least a portion of the obtained information; and
the prompt generation prompt comprises the set of values.

16. The system of claim 12, wherein:
generating the data extraction prompt for extracting the set of data from the obtained information comprises generating, as the data extraction prompt, a prompt that includes instructions for identifying a set of concepts related to at least a portion of the obtained information;
the prompt generation prompt comprises the set of concepts.

17. The system of claim 10, wherein the image generation prompt comprises the identifier for the item and the text presented by the one or more digital components.

18. The system of claim 11, wherein the obtained information comprises an identifier for the item.

19. A non-transitory computer readable storage medium carrying instructions that, when executed by one or more processors, cause the one or more processors to perform operations comprising:
obtaining, by an artificial intelligence system and from one or more data sources, information related to one or more digital components for an item comprising text presented by at least one of the one or more digital components;
generating, by the artificial intelligence system, an image generation prompt based on the obtained information, the image generation prompt comprising image generation instructions for generating an image based on the extracted information;
providing, by the artificial intelligence system, the image generation prompt to an image generation model trained to generate images based on input image generation prompts;
receiving, as an output of the image generation machine learning model, an output image for the item; and
generating, by the artificial intelligence system, an updated digital component using the output image.

20. The non-transitory computer readable storage medium of claim 19, wherein generating the image generation prompt comprises populating an image generation prompt template based on the extracted information, wherein the image generation prompt template comprises at least a portion of the image generation instructions.
